(19) United States
(12) Patent Application Publication
(10) Pub. No.: US 2013/0014585 A1
(43) Pub. Date: Jan. 17, 2013

(54) ACCELEROMETER-BASED TOUCH PAD FOR TIMING SWIMMING AND OTHER COMPETITIVE EVENTS

(71) Applicant: Michael Hetherington, Williamston, MI (US)

(72) Inventor: Michael Hetherington, Williamston, MI (US)

(73) Assignee: P.I. Engineering, Inc., Williamston, MI (US)

(21) Appl. No.: 13/548,365

(22) Filed: Jul. 13, 2012

Related U.S. Application Data
(60) Provisional application No. 61/507,288, filed on Jul. 13, 2011.

(51) Int. Cl. G01P 15/08

(52) U.S. Cl. 73/514.16

(57) ABSTRACT

A touchpad useful in timing competitive sporting events such as swim meets includes a touch plate having a front surface and a back surface, one or more accelerometers coupled to the touch plate, electrical circuitry in communication with the accelerometers to detect motion indicative of a user's touch, and communications circuitry to transmit information indicative of a user's touch to a display, storage device or other remote unit. The back surface of the touch plate may have resilient ridges or a backing structure that more positively ensures contact recording. The circuitry may battery powered with rechargeable batteries. The communications circuitry may use wireless RF technology such as WiFi synchronized absolute time to transmit the touch information to a central timing system. In competitive swimming events, the communications circuitry utilizes a standard Colorado Timing systems banana plug.

### REFERENCE TO RELATED APPLICATION

This application claims priority from. U.S. Provisional Patent Application Ser. No. 61/507,288, filed Jul. 13, 2011, the entire content of which is incorporated herein by reference.

### FIELD OF THE INVENTION

This invention relates generally to sports event timing and, in particular, to an accelerometer-based touch-pad timer for swimming and other competitive events.

### BACKGROUND OF THE INVENTION

Touch pads are currently used in swimming event timing. Existing designs use mechanical switches and rubber membranes to protect the touch regions from the water. Exiting touch pads use a simple switch to indicate to a timing system that a touch has been made. The backing is often plastic, which warps and cracks. The sensitivity is not easily adjustable, and often the device will miss a swimmer's touch. Typical unit cost is high, currently around $800. Additionally, the set up and expense of the cabling involved in traditional systems is problematic.

### SUMMARY OF THE INVENTION

This invention resides in a touchpad useful in timing competitive sporting events such as swim meets. The preferred embodiment includes a touch plate having a front surface and a back surface, one or more accelerometers coupled to the touch plate, electrical circuitry in communication with the accelerometers to detect motion indicative of a user's touch, and communications circuitry to transmit information indicative of a user's touch to a display, storage device or other remote unit.

The accelerometers may be one-, two- or three-axis accelerometers. The back surface of the touch plate may have resilient ridges or a backing structure that more positively ensures contact recording. The circuitry may battery powered with rechargeable batteries. The communications circuitry may use wireless RF technology such as WiFi synchronized absolute time to transmit the touch information to a central timing system. In competitive swimming events, the communications circuitry utilizes a standard Colorado Timing systems banana plug.

### BRIEF DESCRIPTION OF THE DRAWINGS

FIG. 1 is a block diagram associated with the preferred embodiment;

FIG. 2 is a front view drawing of the touch pad;

FIG. 3 is a rear view drawing of the touch pad; and

FIG. 4 shows the front surface of the pad with designated black and white areas.

### DETAILED DESCRIPTION OF THE INVENTION

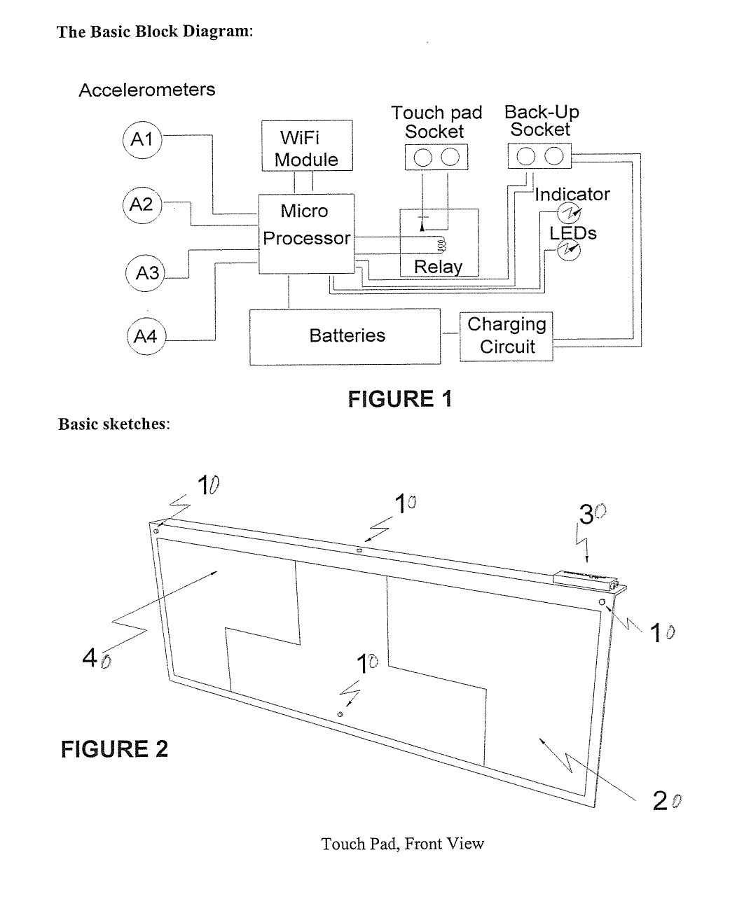

This invention solves problems associated with existing touch pads for swimmers and other competitive events while remaining compatible with existing systems. FIG. 1 is a block diagram associated with the preferred embodiment. FIG. 2 is a perspective drawing of a touch pad 40 according to the invention applicable to swimming related events. The design uses one or more highly sensitive accelerometers 10 to detect the swimmer's touch on the pad 40. These accelerometers are now widely available and cost effective. Additionally, the unit can be wireless and battery operated.

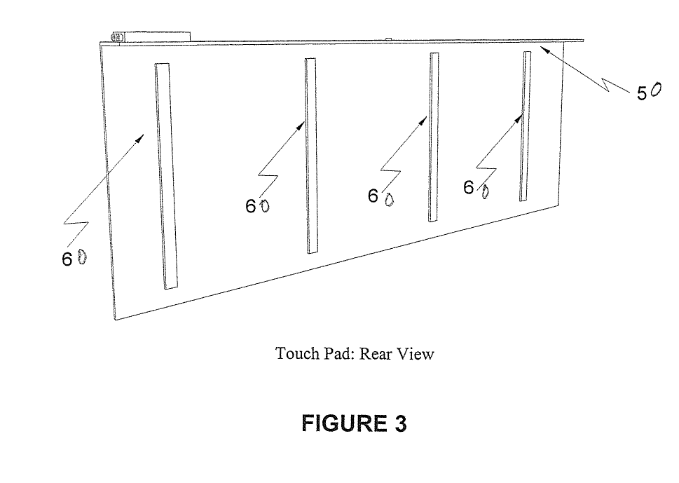

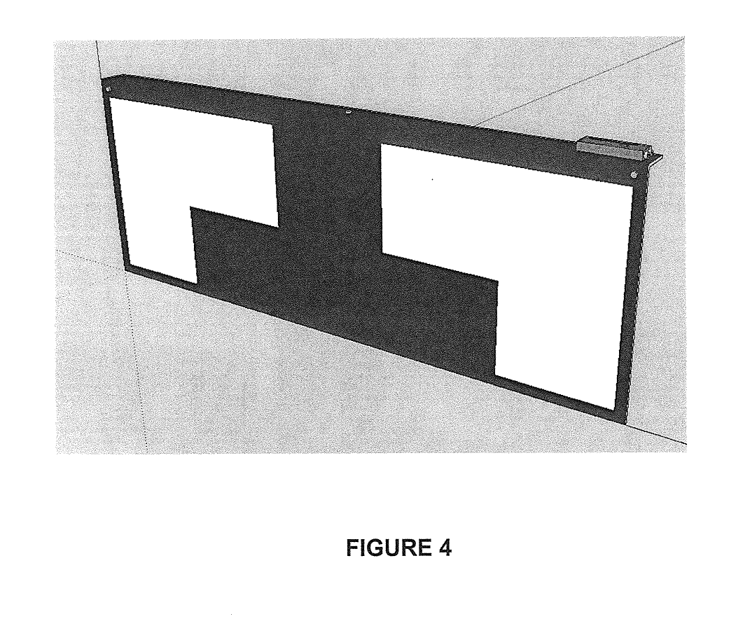

The main structure comprises a stainless steel sheet 20 measuring 60×22 inches with a 3-inch top lip 5 bent in the sheet, as seen in the rear view of the pad in FIG. 3. A larger 72″×22″ version would also be available. The sheet may be coated with poly-urea 40 to protect against moisture and/or define certain regions of the pad. The accelerometers 10 may be adhered to the stainless steel sheet or other substrate back panel before coating. Small resilient ridges 60 may be adhered to the rear of the assembly between the pad and pool wall. These will ensure a small amount of motion exists between the pad and wall so the accelerometers can detect the touch.

A small, battery powered unit 30 may connect to the standard Colorado Timing systems banana plug associated with swim meets or to send WiFi signals. A microprocessor inside the unit 30 monitors the accelerometers and close a small relay or other type of switch. The unit 30 may also send a WiFi message with a calibrated absolute time. As shown in FIG. 1, there may be an input for the back-up hand timer switch. The batteries can be recharged through the back-up switch socket.

The Accelerometers

BMA180 three-axis, ultra-high performance digital accelerometers available from Bosch are applicable to the invention. The BMA180 provides a digital 14-bit output signal via a I2C interface. The full-scale measurement range can be set to ±1 g, 1.5 g, 2 g, 3 g, 4 g, 8 g or 16 g. Other features include programmable wake-up, low-g and high-g detection, tap sensing, slope detection, and self-test capability. The sensor also has two operating modes: low-noise and low-power.

With 14-bit detection on 1 g, a device such as the BMA180 can detect even a very light tap. The unit is used for detecting a tap on smart phone. Controlled with the I2C interface the micro processor can set the sensitivity and use the interrupt to detect a touch of sufficient force to trigger the pad. Wave actions and splashing can be easily be distinguished from a legitimate touch due to the different acceleration profile. This pad can detect the “shock” of a touch or turn and not the pressure from the water.

One or more of these units will be placed around the stainless steel base plate. The unit cost of the accelerometer is less than $5 so even using 4 accelerometers would not be cost prohibitive. For reliable and sensitivity multiple accelerometers will be used. They use the I2C bus to communicate to the micro as well as a single interrupt wire.

The Micro Processor

The Preferred embodiment uses the Cypress PSOIC, which is the standard for a π3 X-keys available from PI Engineering. This processor controls the setup and sensitivity of the accelerometers as well as monitoring the batteries and calibration of the absolute time. When an acceleration profile matches the sensitivity settings, the micro will close a reed relay or other switch and send a UDP message with the absolute time.

WiFi Module

Continuing the reference to FIG. 1, the Roving Networks 171 module is a small fog in factor, ultra low power embedded TCP/IP module measuring only 27×18×3.1 mm. The RN-171 joins the RN-131 module. The RN-171 is a standalone complete TCP/IP wireless networking module. Due to its small form factor and extremely low power consumption, the RN-171 is perfect for mobile wireless applications such as asset monitoring, sensors and portable battery operated devices. The RN-171 incorporates 802.11 b/g radio, 32 bit SPARC processor, TCP/TP stack, real-time clock, crypto accelerator, power management unit and analog sensor interface. The module is pre-loaded with firmware to simplify integration and minimize development time of your application. In the simplest configuration, the hardware only requires four connections (PWR, TX, RX and GND) to create a wireless data connection.

A real-time clock is used to calibrate the absolute time and time-stamp all messages to achieve the required 1/100 second resolution for a swimming timing system. The real-time clock in the module keeps track of the number of seconds since the module was powered on and the actual time when synchronized with the sNTP time server.

The Network Time Protocol (NTP) is a protocol for synchronizing the clocks of computer systems over packet-switched, variable-latency data networks. It is designed particularly to resist the effects of variable latency by using a jitter buffer. Originally designed by David L. Mills of the University of Delaware and still maintained by him and a team of volunteers, it was first used before 1985 and is one of the oldest Internet protocols. The protocol uses the User Datagram Protocol (UDP) on port number 123.

Mechanical Design

As mentioned, in the preferred embodiment the base plate is made from 20 Ga stainless steel. The accelerometers may be epoxied to the plate, with the wires being adhered to the surface before coating. The control unit may be completely encapsulated and water proof before installation on the plate. After placement of all components and testing the entire unit may be coated with poly-urea. This industrial coating is completely waterproof and chemical resistant.

The back of the plate will have a few resilient ridges to ensure that the plate has a bit of motion relative to the pool wall but sufficiently rigid to provide a solid surface for the swimmer to kick off during a turn. These ridges will be placed in such a manner as to mechanically amplify the typical touch so the accelerometers can measure the touch.

The Batteries

The batteries will be rechargeable cells, but allow 3 standard AA cells to be used as a back-up. The compartment will be a straight cylinder with an O-ring seal similar to the seal found in Mag-light flash lights. This type of seal is very reliable and easy to maintain. The batteries can be recharged through the switch input port. The port has a full bridge rectifier so the polarity of the input plug does not matter.

1. A touchpad useful in timing competitive sporting events, comprising:
a touch plate having a front surface and a back surface;
one or more accelerometers coupled to the touch plate;
electrical circuitry in communication with the accelerometers to detect motion indicative of a user's touch; and
communications circuitry to transmit information indicative of a user's touch to a display, storage device or other remote unit.

2. The touchpad of claim 1, wherein the accelerometers are one-, two- or three-axis accelerometers.

3. The touchpad of claim 1, wherein the back surface of the touch plate has resilient ridges or backing structure.

4. The touchpad of claim 1, wherein the circuitry is battery powered.

5. The touchpad of claim 4, wherein the batteries are rechargeable.

6. The touchpad of claim 1, wherein the communications circuitry utilizes wireless WiFi technology.

7. The touchpad of claim 1, wherein the communications circuitry utilizes wireless technology synchronized absolute time to transmit the touch information to a central timing system.

8. The touchpad of claim 1, wherein the communications circuitry utilizes a standard Colorado Timing systems banana plug signals associated with competitive swimming events.
